(19) United States
(12) Patent Application Publication
(10) Pub. No.: US 2017/0066547 A1
(43) Pub. Date: Mar. 9, 2017

(54) LABELING MACHINE

(71) Applicant: COSMO MACHINERY CO., LTD., New Taipei City (TW)

(72) Inventor: Chun Liang Lin, New Taipei City (TW)

(73) Assignee: COSMO MACHINERY CO., LTD., New Taipei City (TW)

(21) Appl. No.: 15/202,668

(22) Filed: Jul. 6, 2016

Related U.S. Application Data
(63) Continuation-in-part of application No. 14/849,182, filed on Sep. 9, 2015.

(51) Int. Cl. B65C 9/00

(52) U.S. Cl. CPC B65C 9/00

(57) ABSTRACT

A labeling machine consisting of multiple rollers, a positioning plate, a power drive, a suction device, a first driving mechanism and a second driving mechanism is disclosed. Thus, a continuous label strip is inserted through gaps in between the rollers and extended over the positioning plate, and then a control unit controls the power drive, the suction device, the first driving mechanism and the second driving mechanism to move the suction device, causing the suction device to suck up one individual label from the continuous label strip at the positioning plate and to adhere the sucked individual label to a cutting lead end of an object, for example, a film roll/bags-on-a-roll.

### CROSS-REFERENCE TO RELATED APPLICATION

The present invention is a continuation-in-part of patent application 14/849,182, filed on Sep. 9, 2015.

### BACKGROUND OF THE INVENTION

1. Field of the Invention

The present invention relates to labeling machine and more particularly, to such a labeling machine practical for use in a film roll/bags-on-a-roll making machine for adhering a label on each slit line of the film roll/bags-on-a-roll made by the film roll/bags-on-a-roll making machine.

2. Description of the Related Art

Commercial plastic wraps are commonly provided in rolls and packed in individual boxes. Many film roll/bags-on-a-roll making machines are known for processing a plastic wrap into rolls, facilitating sales and use.

However, because a plastic wrap is a transparent, soft and thin plastic film, a user cannot easily find out the cut lead end of a plastic wrap roll.

U.S. patent application Ser. No. 14/665895, filed by the present inventor, discloses a film roll/bags-on-a-roll making machine for rapidly dispensing a film/sheet of bags and processing the film/sheet of bags into film rolls/bags-on-a-rolls. However, this design of film roll/bags-on-a-roll making machine has no means to adhere an indicator label to the cut lead end of each film roll/bags-on-a-roll. Because the cut lead end of each film roll/bags-on-a-roll is transparent and thin, the user cannot easily and visually find out the location of the cut lead end or rapidly pick up the cut lead end with the fingers.

Therefore, it is desirable to provide a machine that can adhere a label to a cut lead end of a film roll/bags-on-a-roll automatically and efficiently, enabling the user to find out and to pick up the lead end of the film roll/bags-on-a-roll.

### SUMMARY OF THE INVENTION

The present invention has been accomplished under the circumstances in view. It is therefore one object of the present invention to provide a labeling machine, which can automatically adhere a label onto a cut lead end of a film roll/bags-on-a-roll.

To achieve this and other objects of the present invention, a labeling machine comprises a first roller for working as a driving roller, and a second roller and a third roller respectively peripherally abutted against said first roller for working as driven rollers, a positioning plate disposed adjacent to the first roller, the second roller and the third roller, a label strip let-off reel for letting off a continuous label strip, a label strip take-up reel for taking up the continuous label strip being let off by the label strip let-off reel, a power drive adapted for rotating the first roller and the label strip take-up reel, a suction device disposed near the positioning plate for sucking up one individual label from a continuous label strip being transferred between the label strip let-off reel and the label strip take-up reel by a suction head thereof, a first driving mechanism coupled with the suction device and adapted for moving the suction device alternatively forwards and backwards, and a second driving mechanism coupled with the first driving mechanism and adapted for moving the first driving mechanism and the suction device vertically up and down.

Thus, a continuous label strip is inserted through the gap between the first roller and the second roller and the gap between the first roller and the third roller, and then extended over the positioning plate,

and then a control unit controls the power drive, the suction device, the first driving mechanism and the second driving mechanism to move the suction device, causing the suction device to suck up one individual label from the continuous label strip at the positioning plate and then to adhere the sucked individual label to a cutting lead end of an object, for example, a film roll/bags-on-a-roll.

Thus, the labeling machine can automatically adhere an individual label or sticker to a cut lead end of an object, for example, a film roll/bags-on-a-roll, so that a user can easily and rapidly find out and pick up the cut lead end of the film roll/bags-on-a-roll, improving the problem of being not easy to find out or pick up the cut lead end of a film roll/bags-on-a-roll due to thin thickness or high flexibility of the film.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is schematic side view of a labeling machine in accordance with the present invention.

FIG. 2 is an oblique top elevational view illustrating the labeling machine used in a film roll/bags-on-a-roll making machine in accordance with the present invention.

FIG. 3 is an oblique top elevational view of the labeling machine in accordance with the present invention.

FIG. 4 corresponds to FIG. 3 when viewed from another angle.

FIG. 5 illustrates the positioning relationship between the labeling machine of the present invention and the reel displacement unit of the film roll/bags-on-a-roll making machine.

FIG. 6 is an oblique top elevational view of a part of the labeling machine in accordance with the present invention.

FIG. 7 corresponds to FIG. 6 when viewed from another angle.

FIG. 8 is a schematic side view of the present invention, illustrating the labeling operation of the labeling machine at Step I.

FIG. 9 is a schematic top elevational view of the present invention, illustrating the labeling operation of the labeling machine at Step I.

FIG. 10 is another schematic top elevational view of the present invention, illustrating the labeling operation of the labeling machine at Step I.

FIG. 11 is a schematic side view of the present invention, illustrating the labeling operation of the labeling machine at Step II.

FIG. 12 is a schematic side view of the present invention, illustrating the labeling operation of the labeling machine at Step III.

FIG. 13A is a schematic side view of the present invention, illustrating the labeling operation of the labeling machine at Step IV (I).

FIG. 13B is a schematic side view of the present invention, illustrating the labeling operation of the labeling machine at Step IV (II).

FIG. 14 is a schematic side view of the present invention, illustrating the labeling operation of the labeling machine at Step V.

FIG. 15 is a schematic side view of the present invention, illustrating the labeling operation of the labeling machine at Step VI.

FIG. 16 is a schematic oblique top elevational view of the present invention, illustrating the labeling operation of the labeling machine at Step VI.

FIG. 17 is a schematic side view of the present invention, illustrating the labeling operation of the labeling machine at Step VII.

FIG. 18A is a schematic oblique top elevational view of the present invention, illustrating the labeling operation of the labeling machine at Step VII (I).

FIG. 18B is a schematic oblique top elevational view of the present invention, illustrating the labeling operation of the labeling machine at Step VII (II).

FIG. 19 is a schematic side view of the present invention, illustrating the labeling operation of the labeling machine at Step VIII.

FIG. 20 illustrates the suction device incorporated with a suction head rotational operating air cylinder for adjustment of the adhering angle of the sucked individual label.

FIG. 21 corresponds to FIG. 20, illustrating the angular position of the suction head of the suction device adjusted.

### DETAILED DESCRIPTION OF THE INVENTION

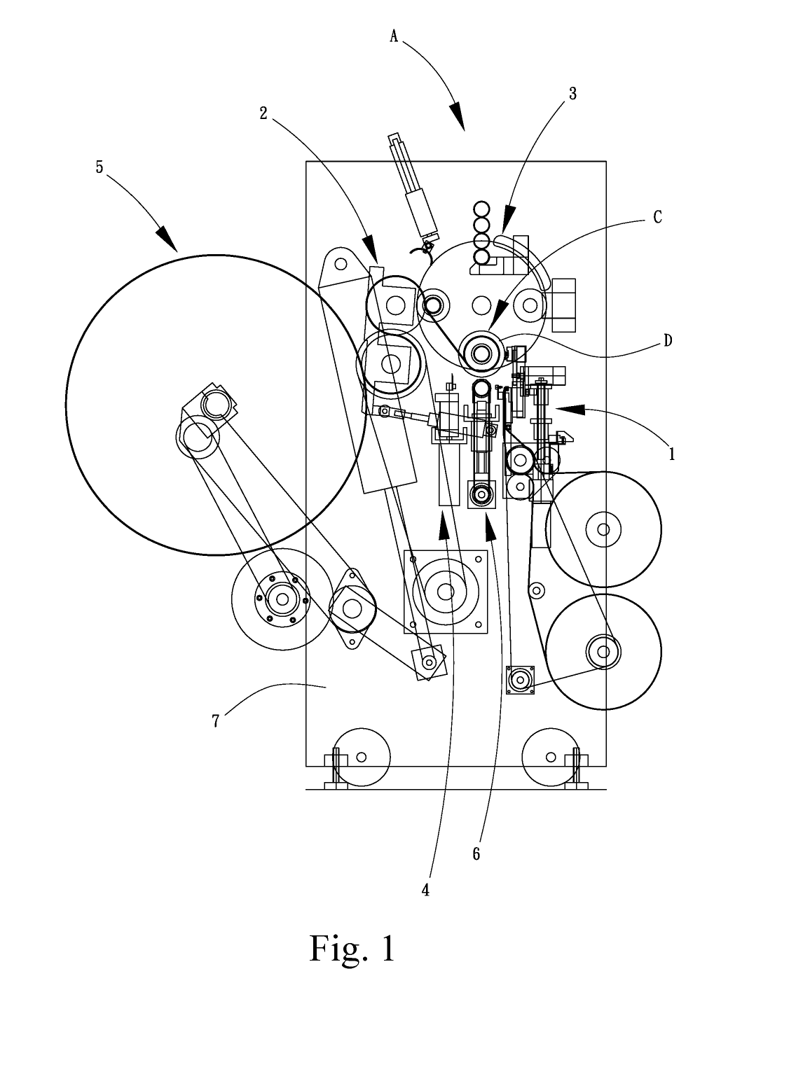

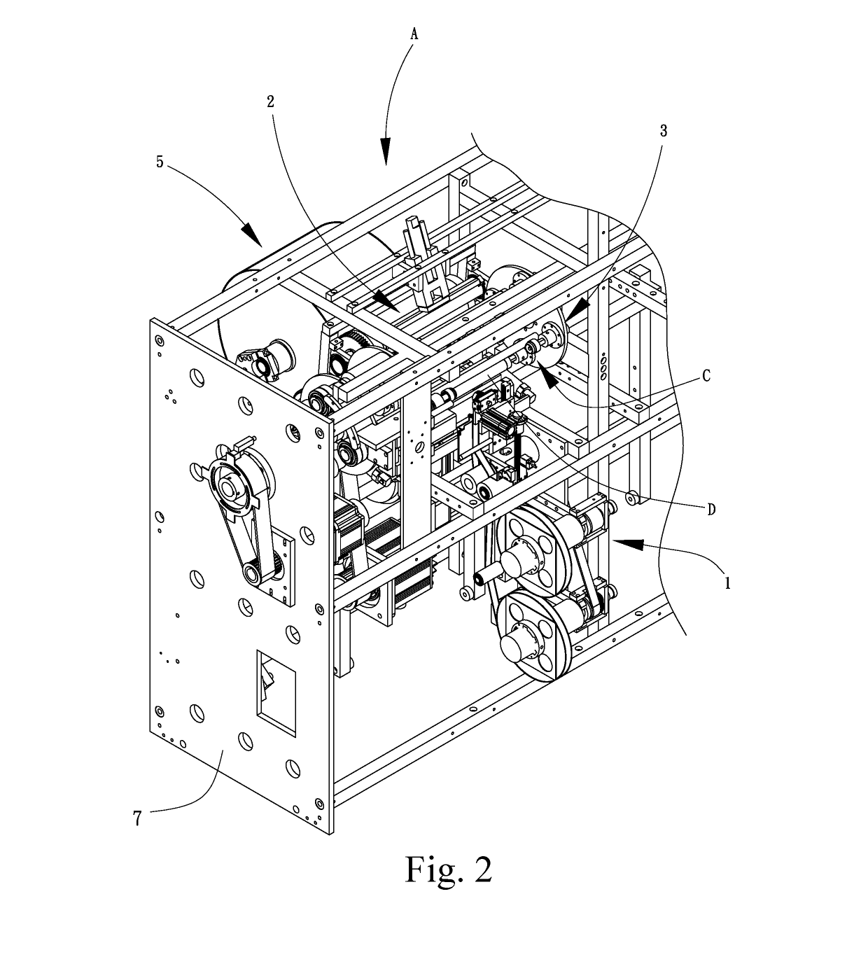

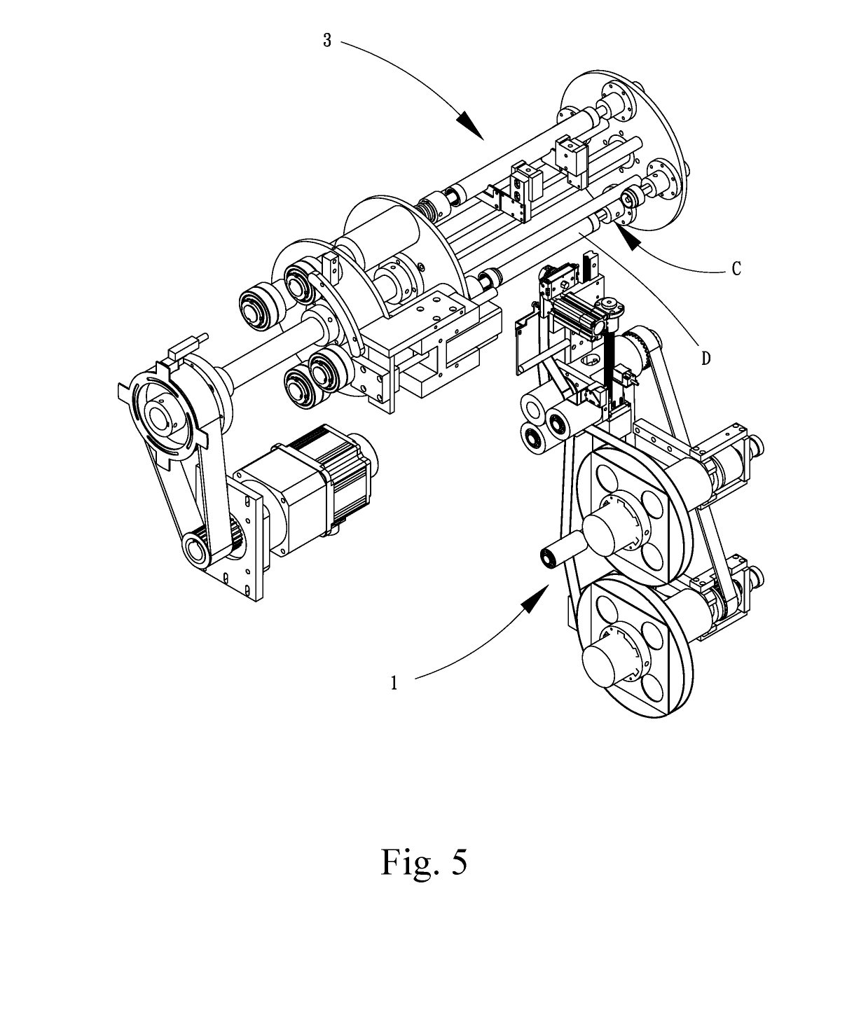

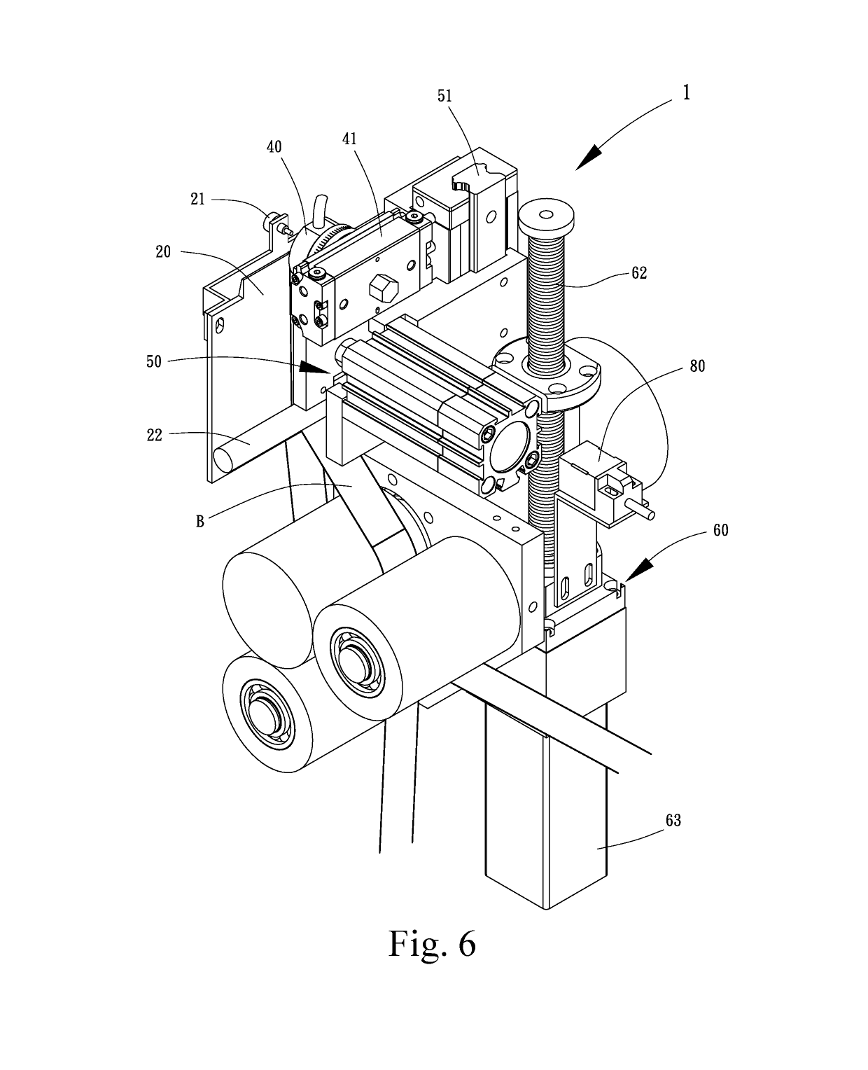

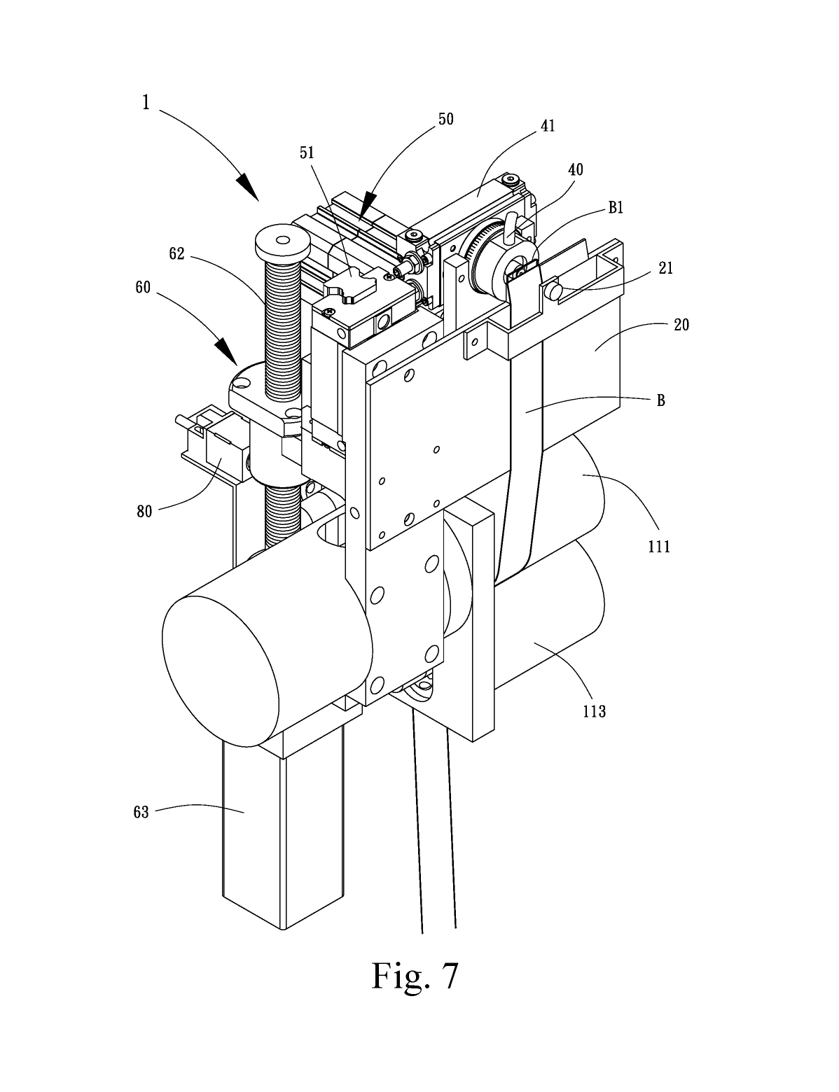

Referring to FIGS. 1-7, a labeling machine 1 in accordance with the present invention is shown attached to one side of a film roll/bags-on-a-roll making machine A (see FIGS. 1 and 2). The film roll/bags-on-a-roll making machine A comprises a feeding unit 2, a reel displacement unit 3, a cut-off mechanism 4, a material holding unit 5, a smoothening unit 6, and a machine base 7.

The labeling machine 1 is disposed adjacent to the film-cutting position C of the reel displacement unit 3 between the film roll/bags-on-a-roll D and the smoothening unit 6. With respective to the structural details of the film roll/bags-on-a-roll making machine A, please refer to U.S. patent application Ser. No. 14/655895, entitled “film roll/bags-on-a-roll making machine”.

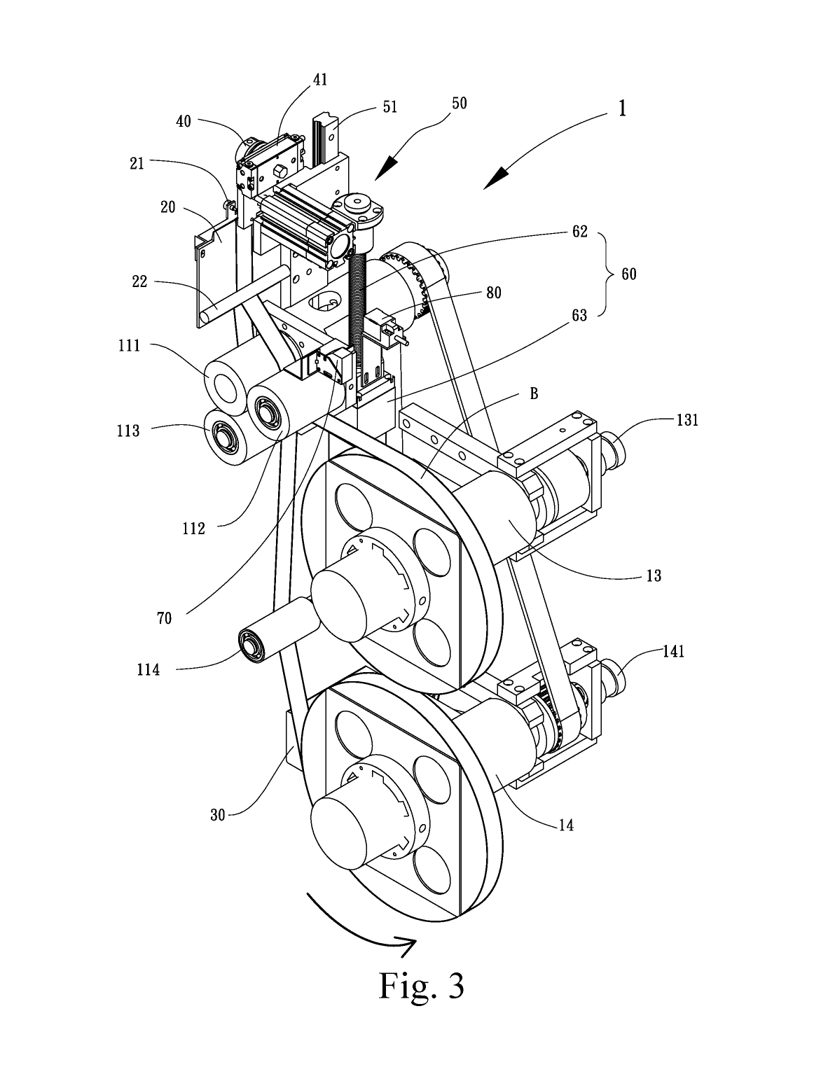

Referring to FIGS. 3-7, the labeling machine 1 comprises a first roller 111 adapted to work as the drive roller, a second roller 112 and a third roller 113 respectively and peripherally abutted against the first roller 111 and adapted to work as driven rollers, a positioning plate 20 disposed adjacent to the first roller 111, the second roller 112 and the third roller 113, a label strip let-off reel 13, a label strip take-up reel 14, a power drive 30 adapted for rotating the first roller 111 and the label strip take-up reel 14, a suction device 40 disposed adjacent to the positioning plate 20, a first driving mechanism 50 adapted for moving the suction device 40 forwards and backwards, a second driving mechanism 60 adapted for moving the first driving mechanism 50 and the suction device 40 up and down for enabling the first driving mechanism 50 and the second driving mechanism 60 to further move the suction device 40 forwards/backwards or upward/downwards to the desired position.

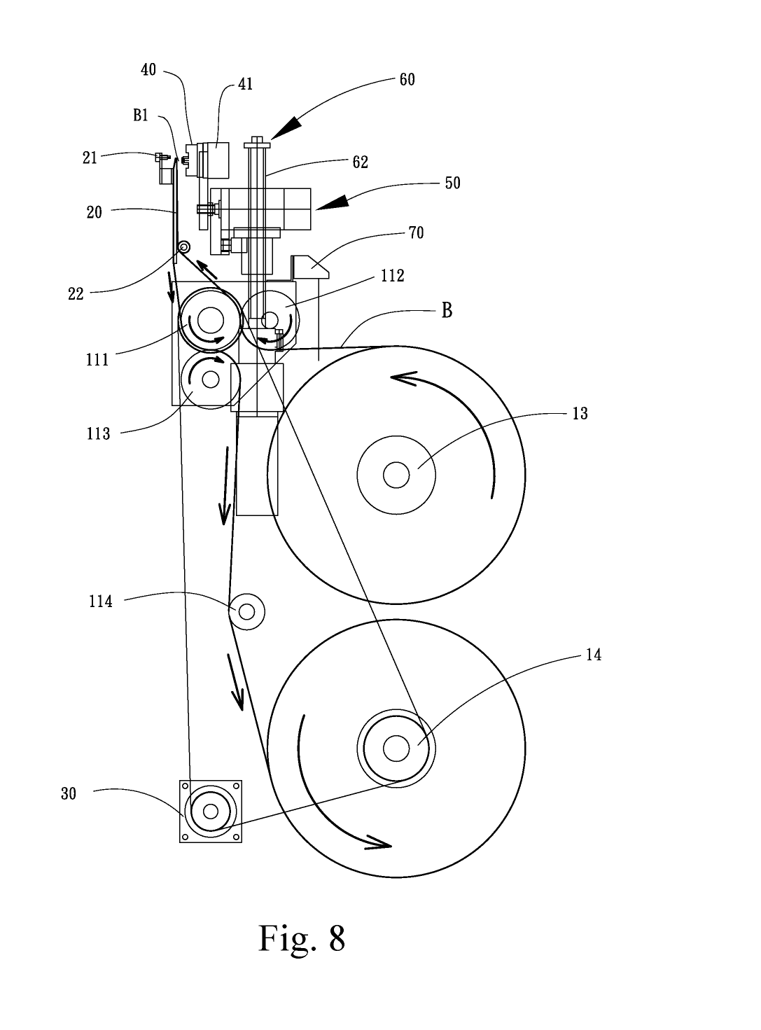

The labeling machine 1 further comprises a continuous label strip B. In this embodiment, the continuous label strip B carries a continuous series of individual labels B1 (see also FIG. 8). The continuous label strip B is rolled up on the label strip let-off reel 13 for supplying the individual labels B1 individually. The label strip take-up reel 14 to take up the blank part of the continuous label strip B after removal of the individual labels B1. In application, roll up the continuous label strip B on the label strip let-off reel 13, and then insert the free end of the continuous label strip B in between the first roller 111 and the second roller 112, enabling the continuous label strip B to be transferred forward or kept at one side of the positioning plate 20, and then extend the continuous label strip B over the topmost edge of the positioning plate 20 to the other side of the positioning plate 20, and then insert the free end of the continuous label strip B through the gap between the first roller 111 and the third roller 113 to the label strip take-up reel 14 so that the label strip take-up reel 14 can take up the blank part of the continuous label strip B. Further, the power drive 30 can be, for example, a motor, or preferably, a servomotor coupled with, for example, a transmission belt to rotate the first roller 111, thereby rotating the second roller 112 and the third roller 113 to transfer the continuous label strip B and to let the blank part of the continuous label strip B to be rolled up by the label strip take-up reel 14.

The labeling machine 1 further comprises a control unit (not shown) electrically coupled with the power drive 30, the suction device 40, the first driving mechanism 50 and the second driving mechanism 60 and adapted for controlling the power drive 30 to drive the first roller 111, the label strip take-up reel 14, the first driving mechanism 50 and the second driving mechanism 60 subject to predetermined control instructions.

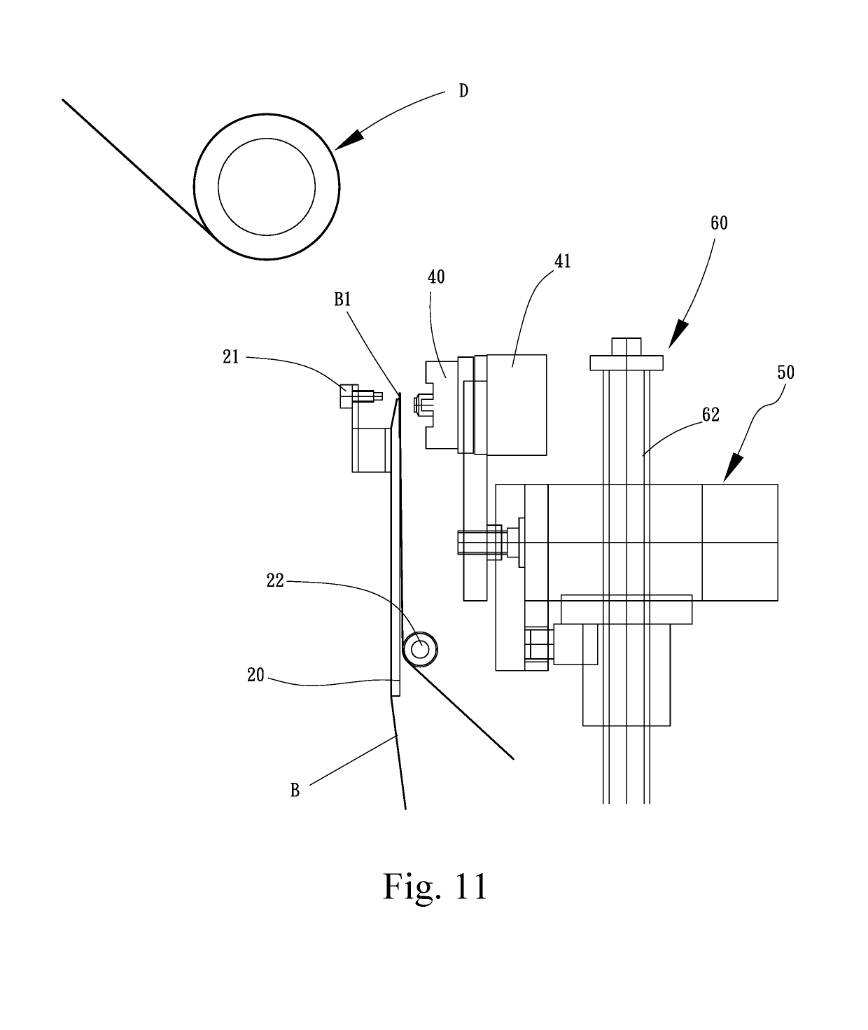

Referring also to FIG. 11, the continuous label strip B is to be delivered along the surface of the positioning plate 20. When one individual label B1 of the continuous label strip B reaches a predetermined position at one side of the positioning plate 20, for example, the position in proximity to the top side of the positioning plate 20, the control unit controls the first driving mechanism 50 and the second driving mechanism 60 to move the suction device 40 into alignment with the said individual label B1, and then controls the suction device 40 to suck up the said individual label B1 from the continuous label strip B, and thus, the suction device 40 can be controlled to adhere the said individual label B1 to an object, for example, the cut lead end of a film roll/bags-on-a-roll D.

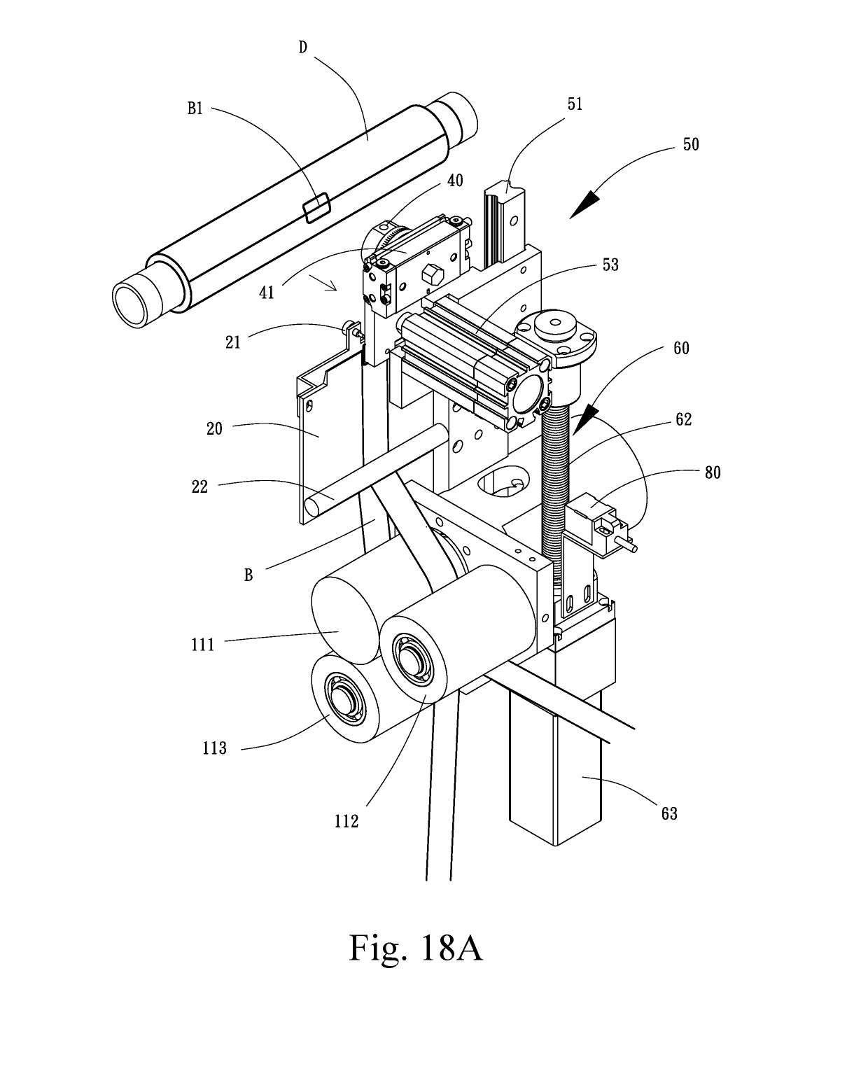

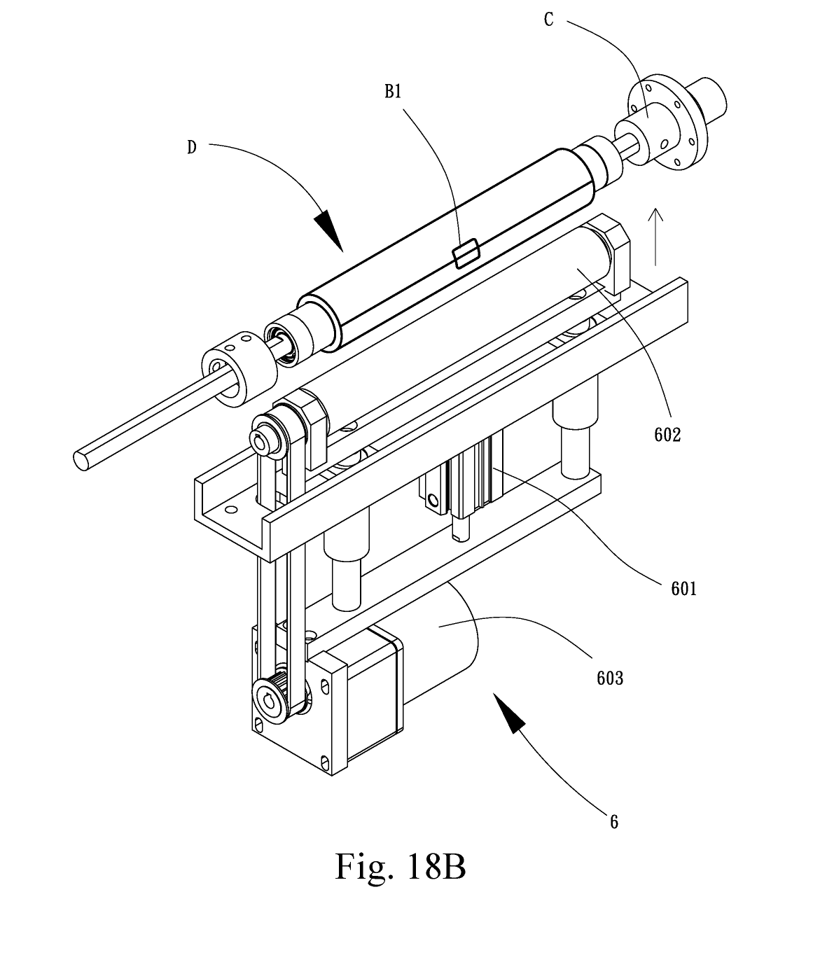

Referring to FIG. 18A, the invention can automatically and efficiently adhere an individual label B1, or sticker, to the cut lead end of a film roll/bags-on-a-roll D so that a user can easily and rapidly find out and pick up the cut lead end of the film roll/bags-on-a-roll D, improving the problem of being not easy to find out or pick up the cut lead end of a film roll/bags-on-a-roll due to thin thickness or high flexibility of the film.

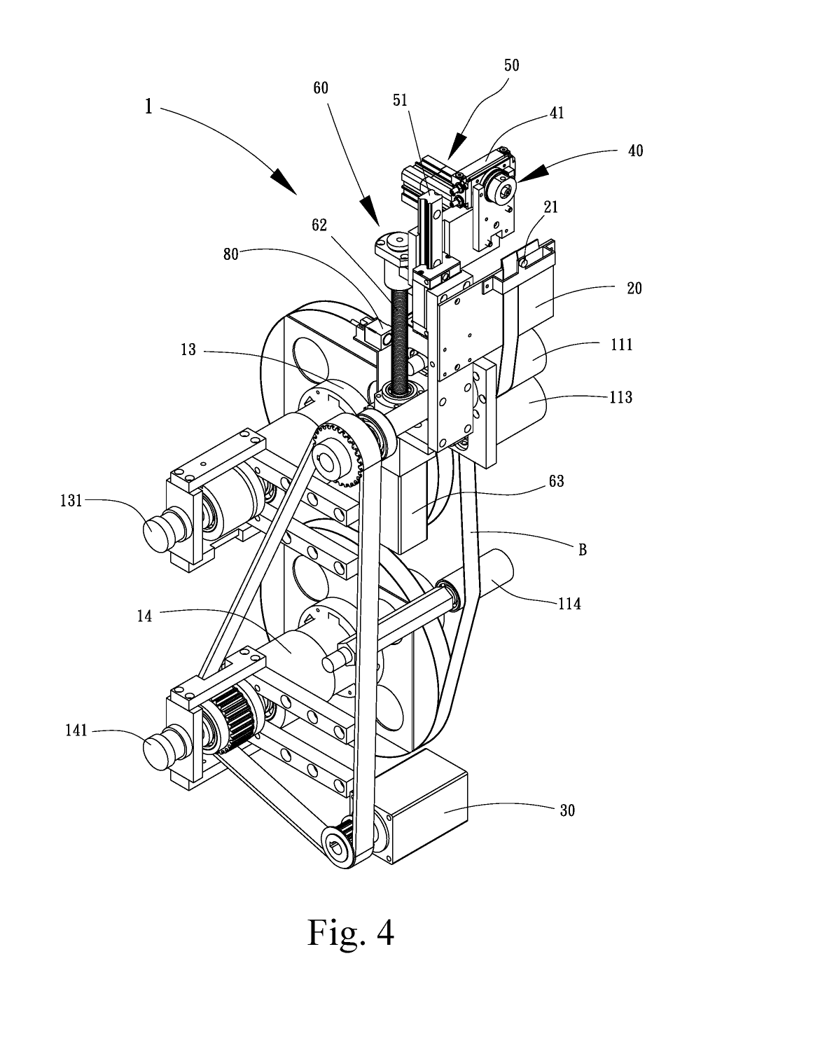

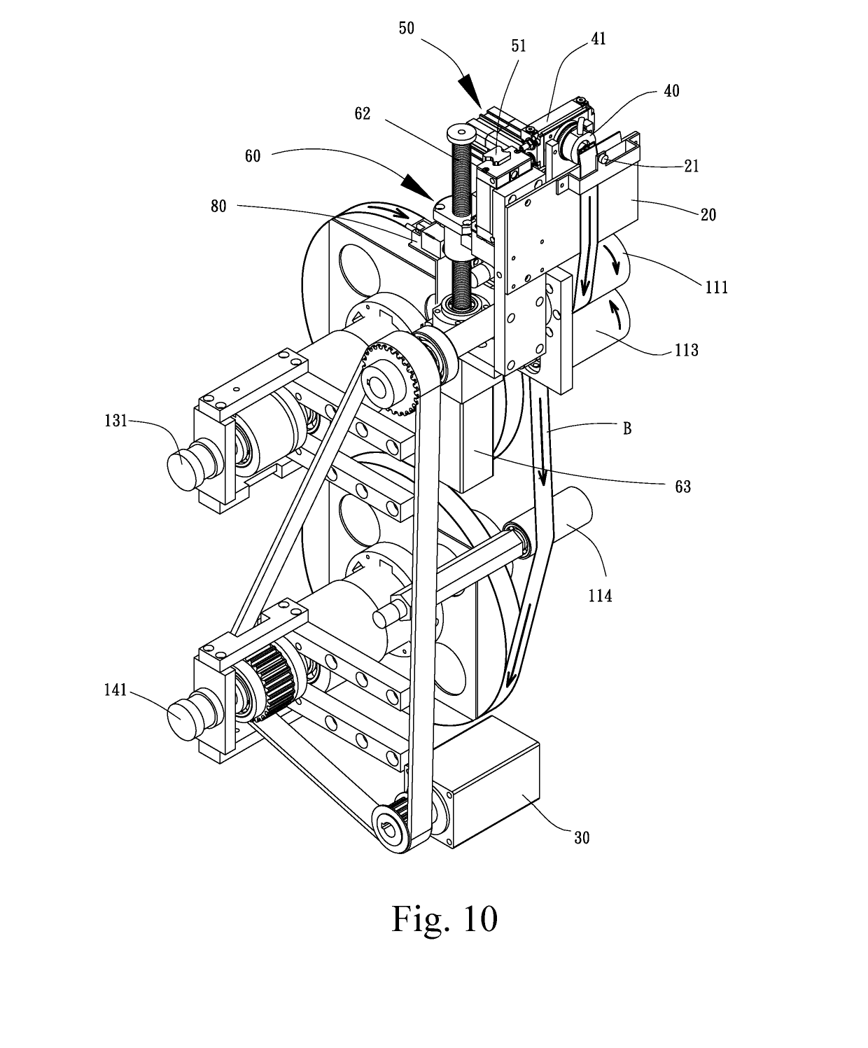

Referring to FIGS. 4 and 10, in one embodiment of the present invention, the label strip let-off reel 13 comprises a tensioning device 131 located one lateral side thereof; the continuous label strip take-up reel 14 comprises a tensioning device 141 located one lateral side thereof. Thus, when the power drive (motor) 30 drives the label strip let-off reel 13 to let off the continuous label strip B and the label strip take-up reel 14 to take up the continuous label strip B, the continuous label strip B can be smoothly let off or taken up, assuring a high level of reliability.

Referring also to FIG. 4 or FIGS. 6-21, in one embodiment of the present invention, a label position sensor 21 is mounted at one side of the positioning plate 20 and electrically connected to the control unit, and controlled by the control unit to detect the presence of one individual label B1 in a predetermined position, i.e., to detect the presence of one individual label B1 of the continuous label strip B in a suction position on the positioning plate 20 for sucking by the suction device 40.

Referring also to FIG. 3 or FIGS. 6-21, in one embodiment of the present invention, a positioning rod 22 is located at an opposite side of the positioning plate 20. The continuous label strip B is inserted through the gap between the positioning plate 20 and the positioning rod 22. The positioning rod 22 is adapted to keep the continuous label strip B in contact with the surface of the positioning plate 20.

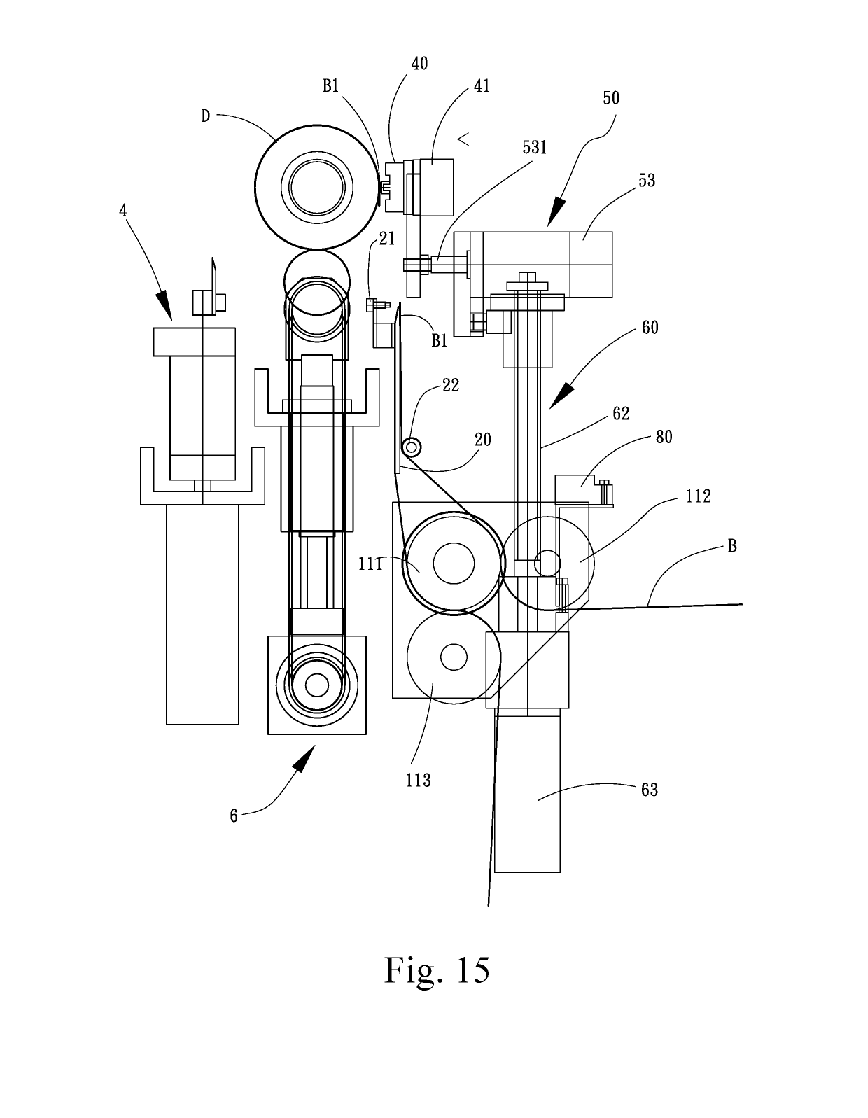

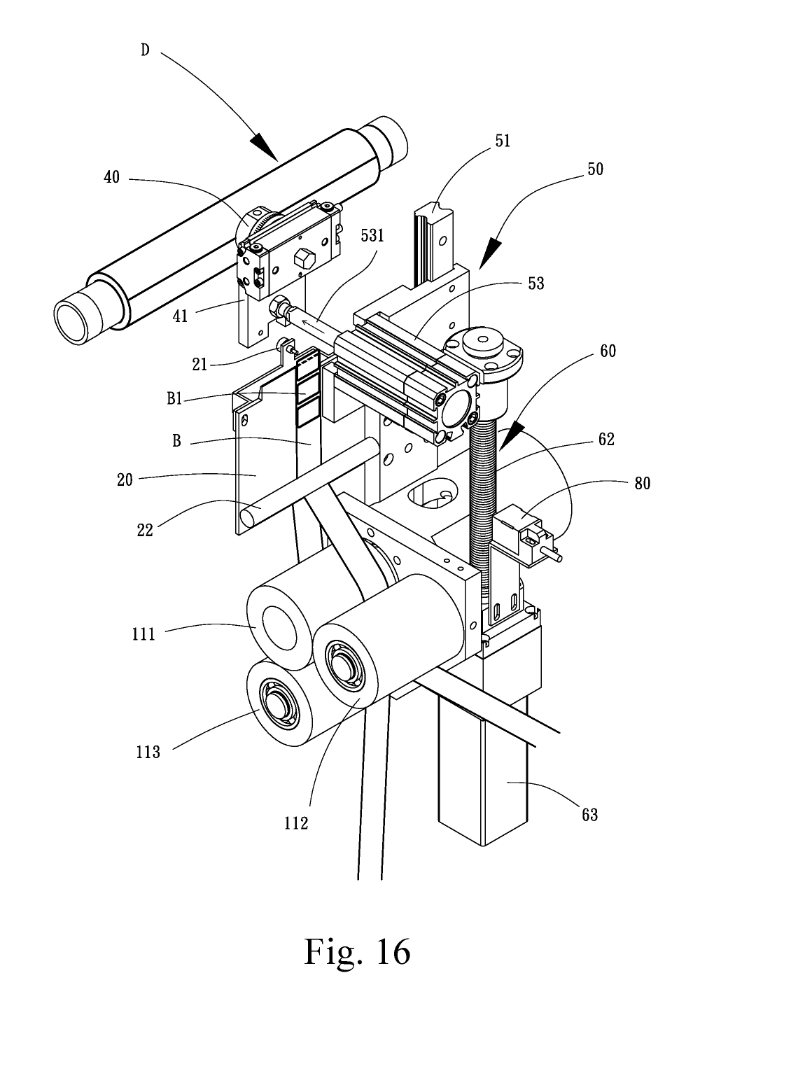

Referring also to FIGS. 15 and 16, in one embodiment of the present invention, the first driving mechanism 50 comprises an air cylinder 53 coupled to and drivable by the second driving mechanism 60. The air cylinder 53 comprises a piston rod 531 that has the free end thereof connected to the suction device 40. The piston rod 531 is drivable by the second driving mechanism 60 to move in and out of the air cylinder 53, thereby moving the suction device 40 horizontally forwards or backwards.

In one embodiment of the present invention, the second driving mechanism 60 comprises a screw device 62, and a motor 63 coupled with the screw device 62 and adapted for rotating the screw device 62. The air cylinder 53 of the first driving mechanism 50 is coupled to the screw device 62 of the second driving mechanism 60. The first driving mechanism 50 comprises a guide device 51 connected to the air cylinder 53. In this embodiment, the guide device 51 is a mating structure of a guide rail and a guide groove. The motor 63 of the second driving mechanism 60 is electrically coupled to the aforesaid control unit, and controllable by the aforesaid control unit to rotate the screw device 62 clockwise or counter-clockwise, causing the first driving mechanism 50 to move upwards or downwards along the screw device 62. Further, the guide device 51 enhances the stability of the movement of the first driving mechanism 50.

In one embodiment of the present invention, the labeling machine 1 further comprises a label blanking sensor 70 facing toward the continuous label strip B near the label strip let-off reel 13 and remote from the label strip take-up reel 14, and adapted for detecting a no-individual label status.

In one embodiment of the present invention, the labeling machine 1 further comprises a lift position sensor 80 disposed near the screw device 62, and adapted for detecting the position of the first driving mechanism 50 during its vertical displacement, ensuring accurate positioning of the first driving mechanism 50.

Referring also to FIGS. 1 and 18B, in one embodiment of the present invention, the smoothening unit 6 of the film roll/bags-on-a-roll making machine A is disposed near the film roll/bags-on-a-roll D in the film-cutting position C of the reel displacement unit 3. The smoothening unit 6 comprises a smoothing unit pneumatic cylinder 601, a smoothing roller 602, a smoothening unit power drive 603. The smoothening unit power drive 603 is coupled with the smoothing roller 602. The smoothing unit pneumatic cylinder 601 is controllable to move the smoothing roller 602 into contact with the film roll/bags-on-a-roll D. The smoothening unit power drive 603 is controllable to rotate the smoothing roller 602, smoothening the edge of the film/sheet of bags A of the duly finished film roll/bags-on-a-roll and the adhered individual label Bl.

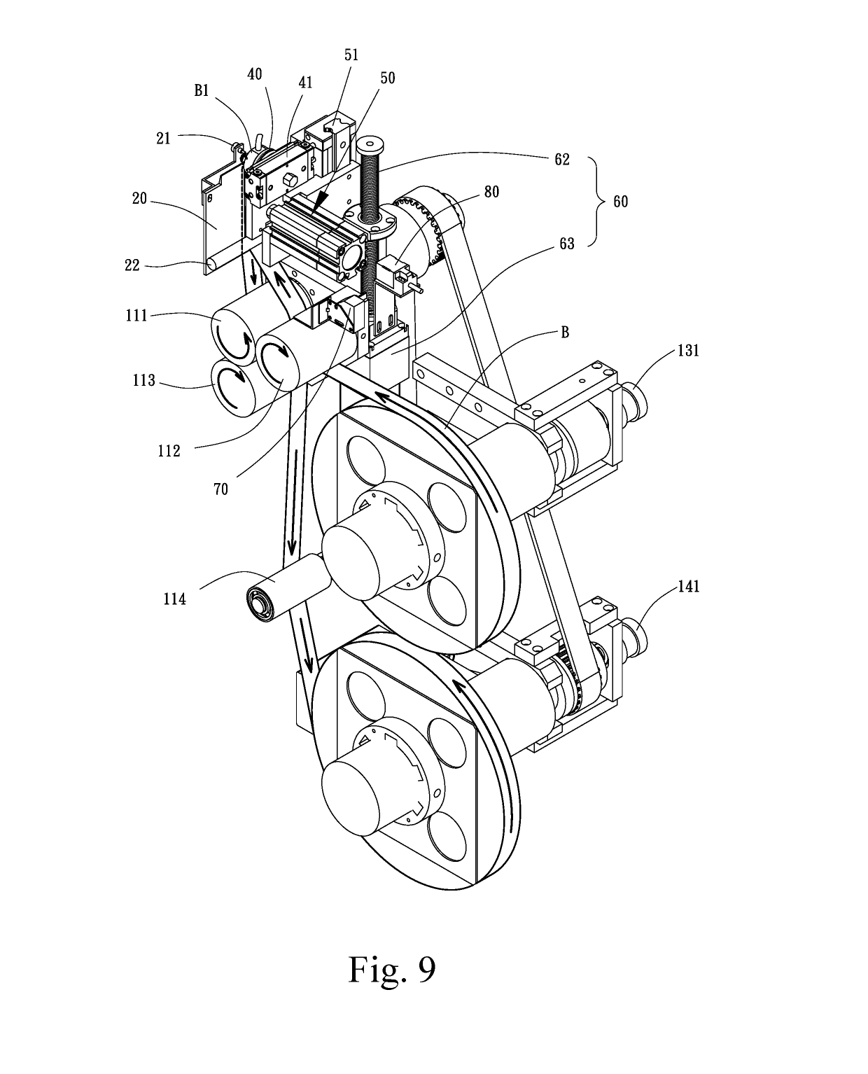

Referring to FIG. 8, FIG. 9 and FIG. 10, the labeling operation of the labeling machine 1 comprises the following Steps I-VIII.

Step I: The control unit starts up the operation of the labeling machine 1 after a predetermined length of the finished film roll/bags-on-a-roll D has been delivered out of the film roll/bags-on-a-roll making machine A, and then controls the power drive 30 to rotate the first roller 111. During rotation of the first roller 111, the second roller 112 and the third roller 113 are caused by friction to rotate in the reversed direction, causing the label strip let-off reel 13 to let off the continuous label strip B and the label strip take-up reel 14 to synchronously take up the continuous label strip B.

Step II. As illustrated in FIG. 11, the label position sensor 21 detects that one individual label B1 of the continuous label strip B has reached the predetermined suction position on the positioning plate 20, the control unit immediately controls the power drive 30 to stop its operation, stopping the continuous label strip B in position. Immediately after the power drive 30 is stopped, the control unit controls the suction device 40 to suck up the respective individual label B1.

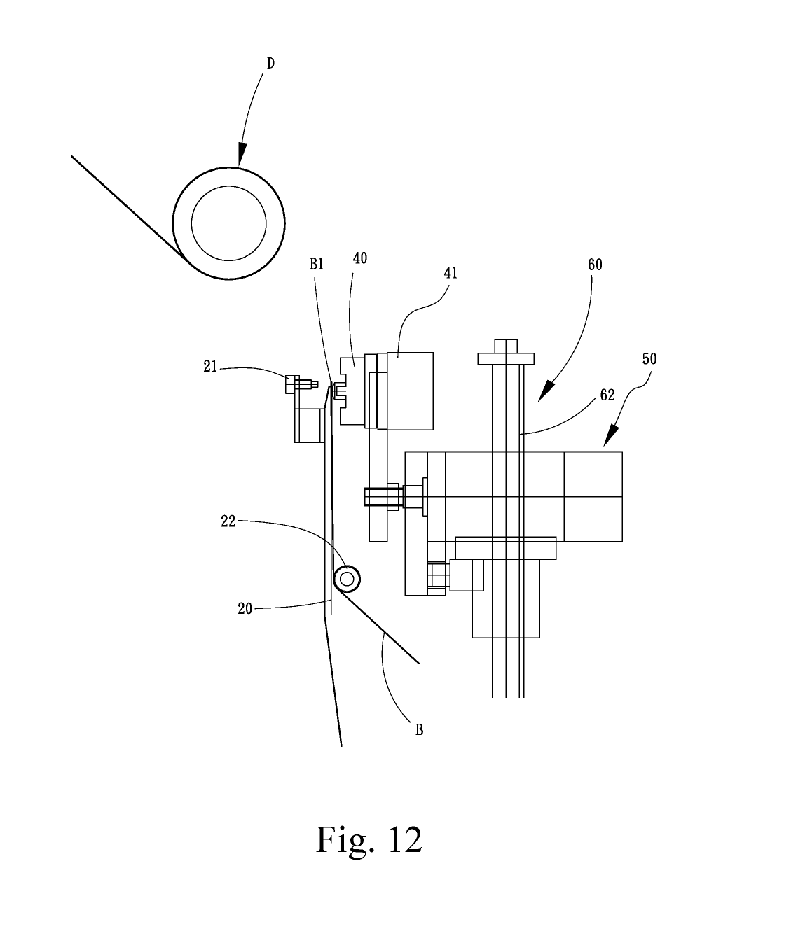

Step III: As illustrated in FIG. 12, the first driving mechanism 50 is controlled to extend out its piston rod, moving the suction device 40 to the said individual label B1 at the positioning plate 20 to suck up the said individual label B1, and the air cylinder 53 of the first driving mechanism 50 is stopped at this time.

In one embodiment of the present invention, the first driving mechanism 50 uses two pneumatic tubes to control movement of two piston rods in reversed directions, for example, forward or backward movement.

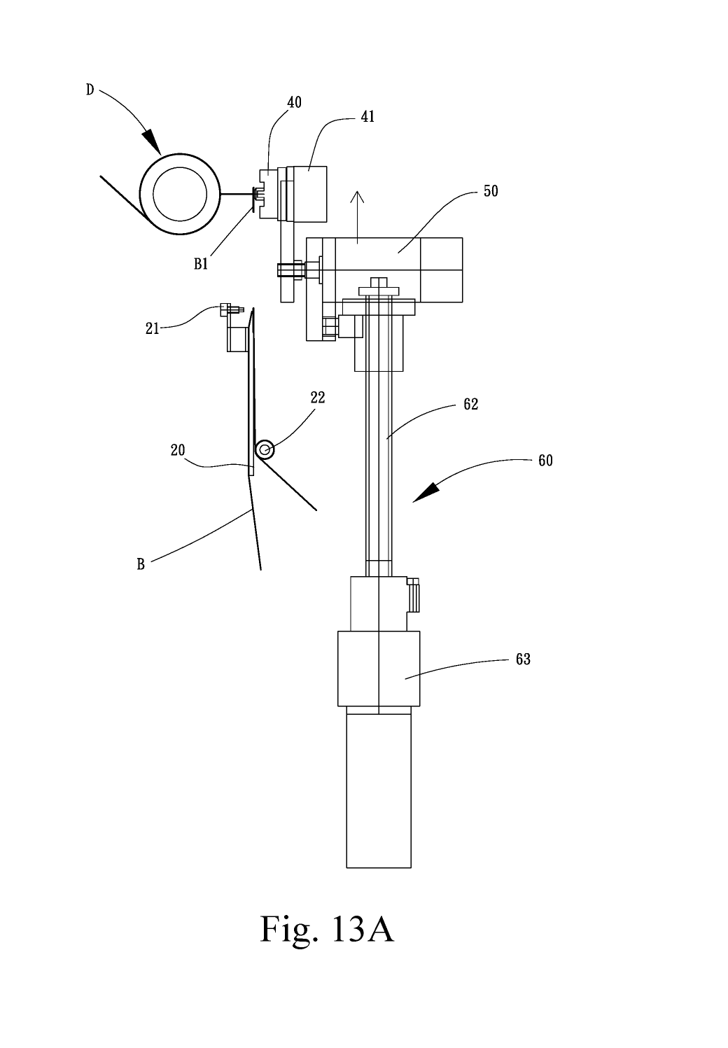

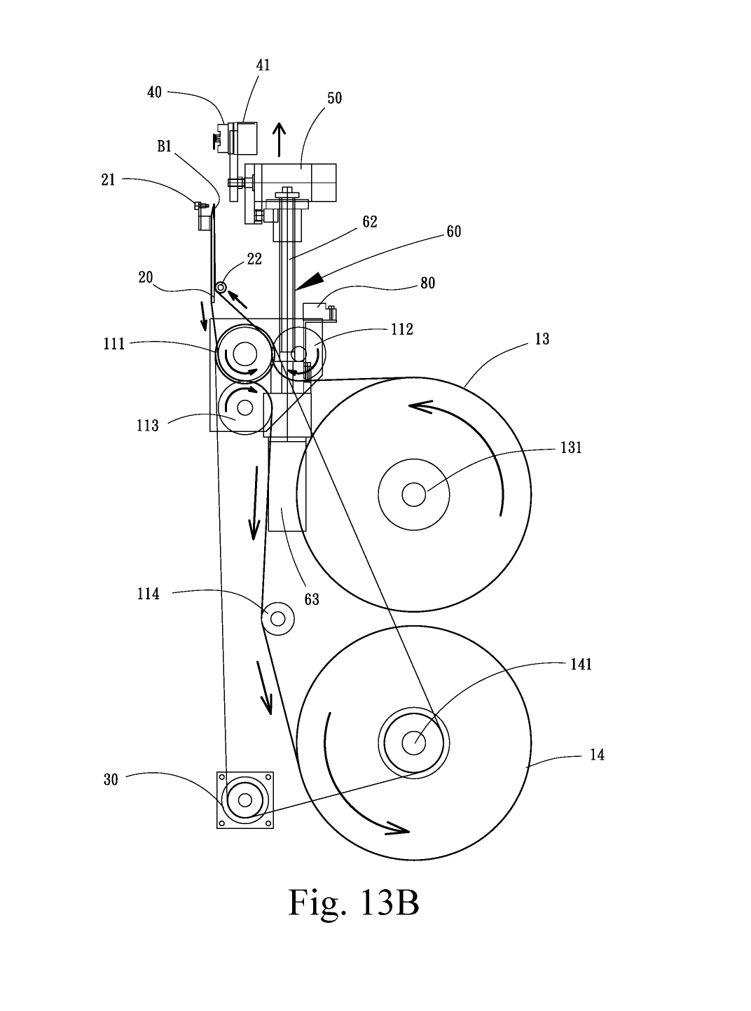

Step IV: As illustrated in FIG. 13A and FIG. 13B, the motor 63 of the second driving mechanism 60 is controlled to rotate the screw device 62, causing movement of the suction device 40 upwardly along the screw device 62, and at the same time, the said individual label B1 is carried away from the continuous label strip B by the suction device 40 and then stopped at one side of the film roll/bags-on-a-roll D.

When the suction device 40 is being caused to move upwards, the power drive 30 is controlled to rotate the label strip let-off reel 13 and the continuous label strip take-up reel 14, causing the label strip let-off reel 13 to let off a predetermined length of the continuous label strip B and the label strip take-up reel 14 to take up an equal length of the continuous label strip B, and then the power drive 30 is stopped after the next individual label B1 is moved to the top side of the positioning plate 20.

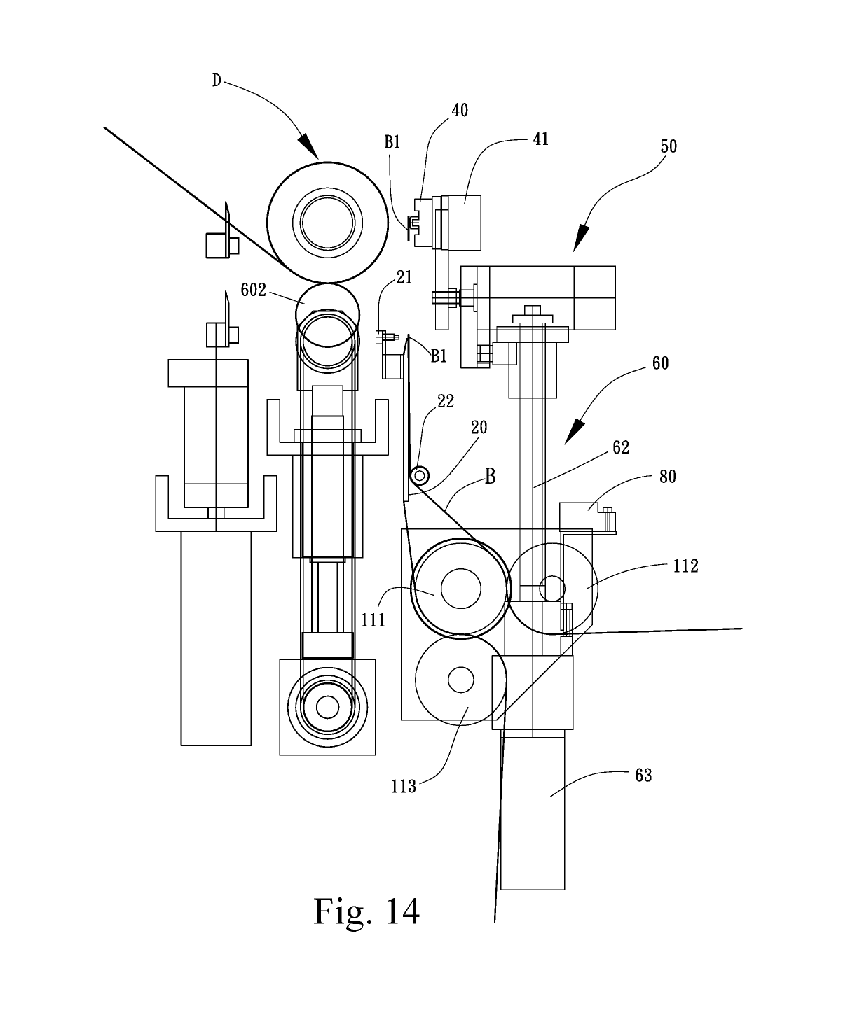

Step V: As illustrated in FIG. 14, the cut-off mechanism 4 drives a pneumatic device set (not shown) to move a cutter 401 upwards, causing the cutter 401 to cut off the dispensing film roll/bags-on-a-roll D. The cutter 401 is then lowered after the cutting action. With respect to the structure of the cut-off mechanism 4, please refer to “film roll/bags-on-a-roll making machine” of U.S. patent application Ser. No. 14/665895.

At the time the cutter 401 cuts off the film roll/bags-on-a-roll D, the smoothing unit pneumatic cylinder 601 is controlled to move the smoothing roller 602 upwardly into contact with the film roll/bags-on-a-roll D, and then the smoothening unit power drive 603 is controlled to rotate the smoothing roller 602, smoothening the film roll/bags-on-a-roll D. At this time, the smoothing roller 602 is kept in the lifted position.

Step VI: As illustrated in FIG. 15 and FIG. 16, after smoothened the film roll/bags-on-a-roll D, the first driving mechanism 50 fully extends out the piston rod thereof, causing the suction device 40 to adhere the sucked individual label B1 to the cut lead end of the film roll/bags-on-a-roll D, simulating the action of a person to manually adhere one individual label B1 to the cut lead end of the film roll/bags-on-a-roll D.

After the individual label B1 is adhered to the cut lead end of the film roll/bags-on-a-roll D, the control unit controls the suction device 40 to release its suction force.

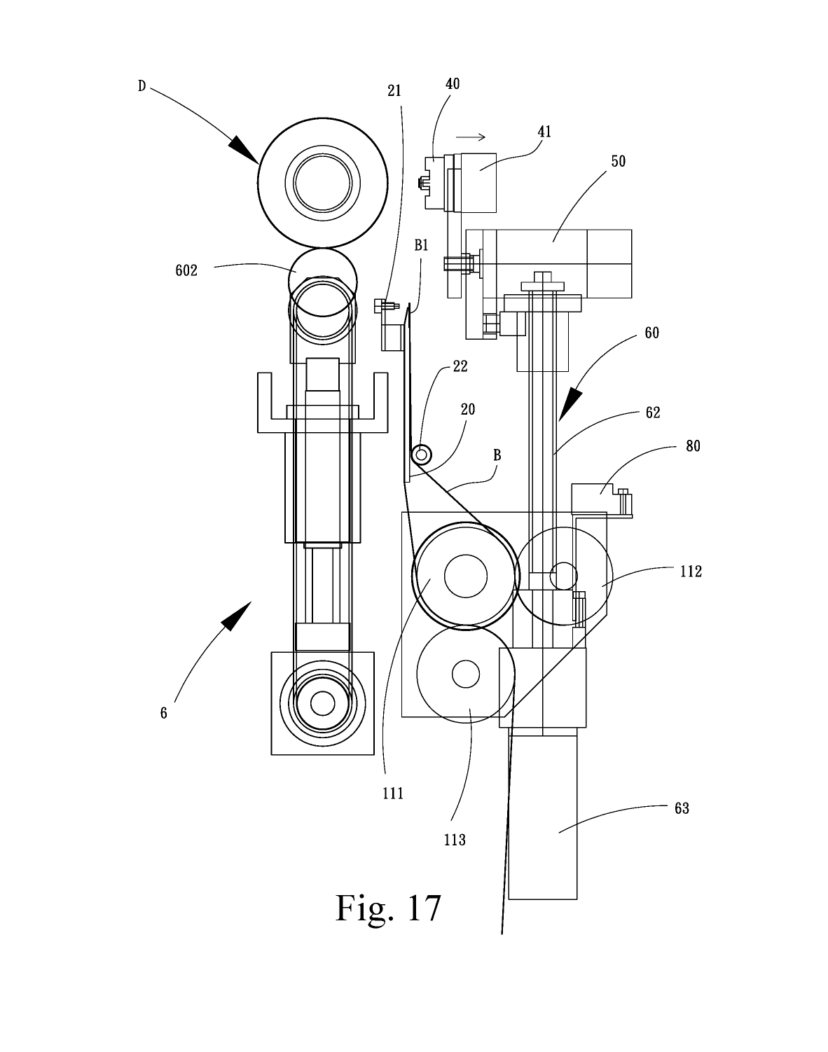

Step VII: As illustrated in FIG. 17, FIG. 18A and FIG. 18B, after the individual label B1 is adhered to the film roll/bags-on-a-roll D, the first driving mechanism 50 retracts the piston rod thereof to the original received position.

After the piston rod of the first driving mechanism 50 has been completely retracted, the smoothing roller 602 of the film roll/bags-on-a-roll making machine A is rotated again to smoothen the individual label B1, and then the smoothing roller 602 is lowered to its original position.

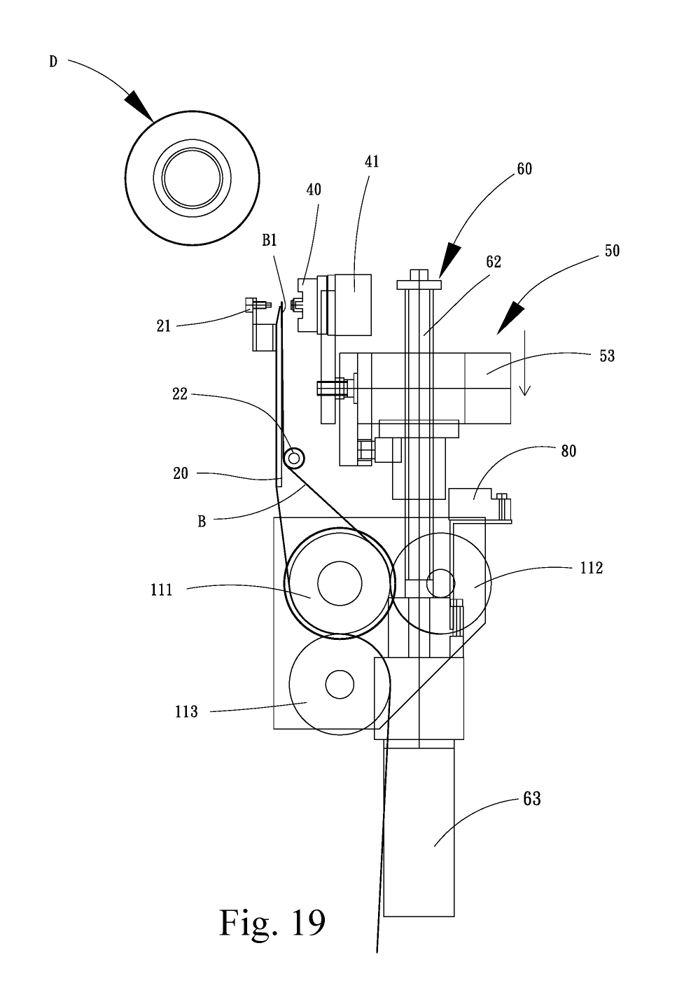

Step VIII: As illustrated in FIG. 19, the motor 63 of the second driving mechanism 60 is controlled to rotate the screw device 62, causing the suction device 40 to be moved downwardly along the screw device 62 to the position in alignment with the next individual label B1.

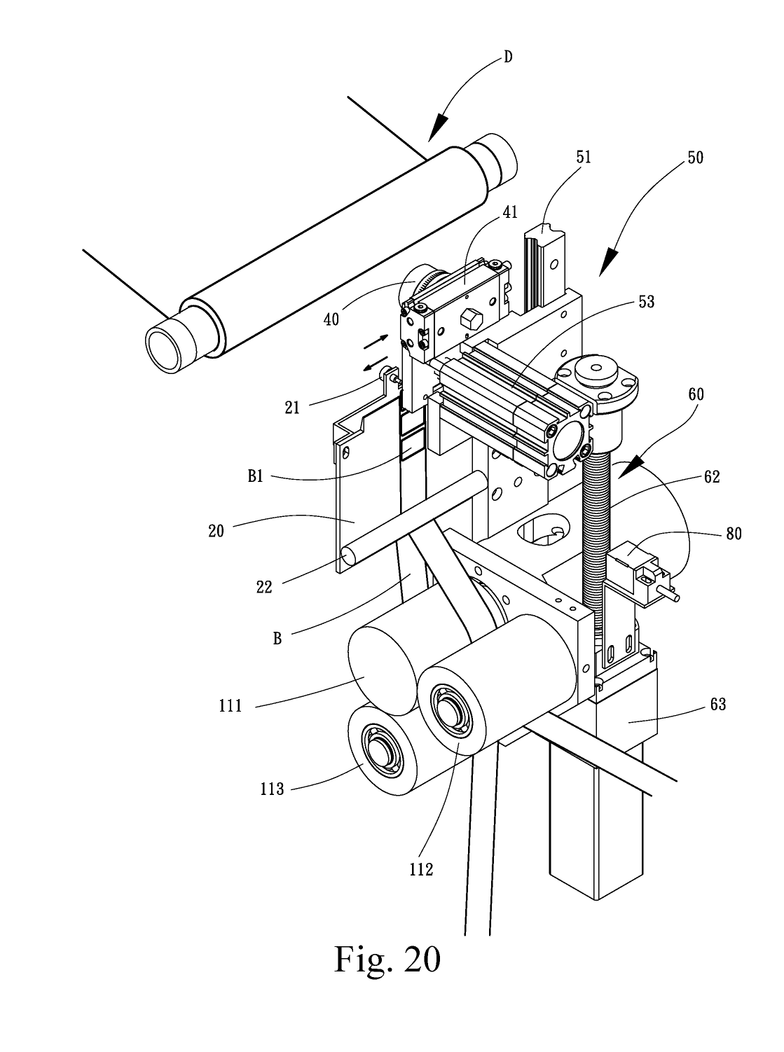

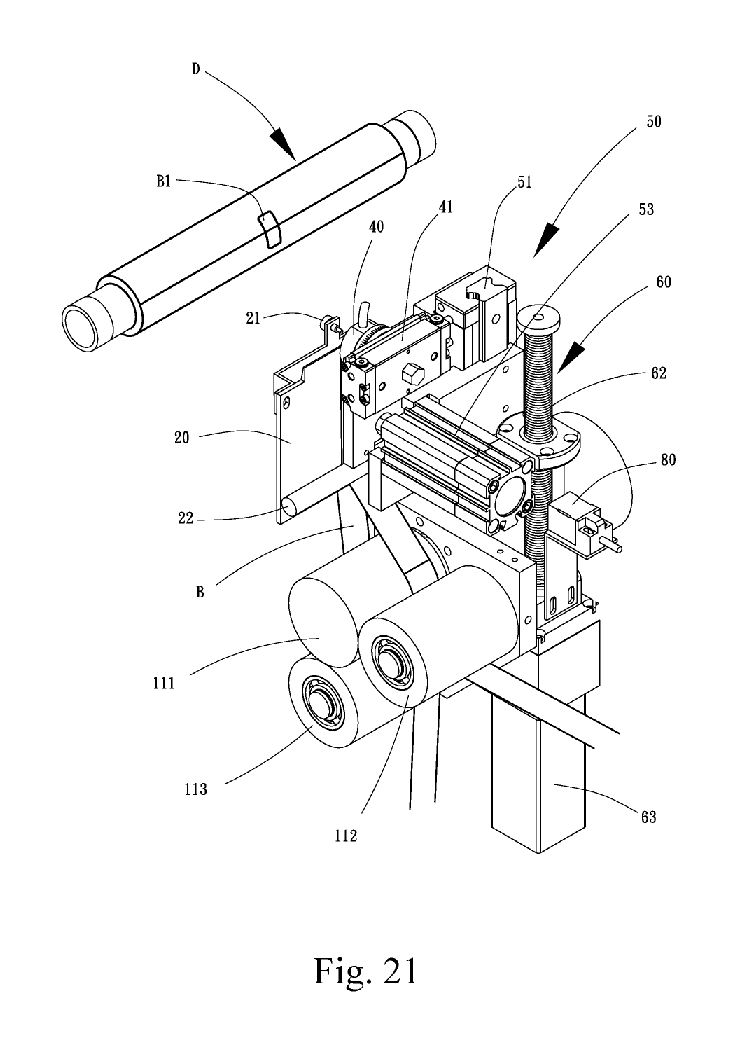

Referring to FIG. 20 and FIG. 21, in one embodiment of the present invention, the suction device 40 comprises a suction head rotational operating air cylinder 41 adapted for rotating the suction head of the suction device 40 through a predetermined angle, for example, 90 degrees, so that the sucked individual label B1 can be rotated with the suction head of the suction device 40 through the predetermined angle, adjusting the adhering angle of the individual label B1 on the film roll/bags-on-a-roll D, for example, changing the adhering angle of the individual label B1 on the film roll/bags-on-a-roll D from vertical to horizontal.

Referring to FIGS. 3 and 4 and FIGS. 8-10, the labeling machine 1 further comprises a guide wheel 114 disposed in the label strip delivering path between the third roller 113 and the label strip take-up reel 14 and adapted to guide the continuous label strip B away from the label strip let-off reel 13, enabling the continuous label strip B to be smoothly tack up by the label strip take-up reel 14.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A labeling machine, comprising:
a first roller for working as a driving roller, and a second roller and a third roller respectively peripherally abutted against said first roller for working as driven rollers;
a positioning plate disposed adjacent to said first roller, said second roller and said third roller;
a label strip let-off reel for letting off a continuous label strip;
a label strip take-up reel for taking up the said continuous label strip being let off by said label strip let-off reel;
a power drive adapted for rotating said first roller and said label strip take-up reel;
a suction device disposed near said positioning plate for sucking up one individual label from a continuous label strip being transferred between said label strip let-off reel and said label strip take-up reel by a suction head thereof;
a first driving mechanism coupled with said suction device and adapted for moving said suction device alternatively forwards and backwards; and
a second driving mechanism coupled with said first driving mechanism and adapted for moving said first driving mechanism and said suction device vertically up and down.

2. The labeling machine as claimed in claim 1, further comprising a continuous label strip carrying a continuous series of individual labels, said continuous label strip being rolled up on said label strip let-off reel, said continuous label strip having a free end extended out of said label strip let-off reel and then inserted in between said first roller and said second roller and then extended from one side of said positioning plate to an opposite side of said positioning plate in direct contact with said positioning plate and then inserted in between said first roller and said third roller and then extended to said label strip take-up reel for enabling said label strip take-up reel to take up said continuous label strip from said label strip let-off reel.

3. The labeling machine as claimed in claim 1, further comprising a control unit electrically coupled with said power drive, said suction device, said first driving mechanism and said second driving mechanism and adapted for controlling the operation of said power drive, said suction device, said first driving mechanism and said second driving mechanism.

4. The labeling machine as claimed in claim 3, wherein said label strip let-off reel comprises a tensioning device located at one lateral side thereof; said label strip take-up reel comprises a tensioning device located at one lateral side thereof.

5. The labeling machine as claimed in claim 1, further comprising a label position sensor mounted at one side of said positioning plate and electrically connected to said control unit, and controllable by said control unit to detect the presence of one said individual label in a predetermined suction position on said positioning plate for sucking by said suction device.

6. The labeling machine as claimed in claim 1, further comprising a positioning plate located at an opposite side of said positioning plate opposite to said label position sensor and adapted to keep said continuous label strip in close contact with the surface of said positioning plate, wherein said continuous label strip is inserted through a gap between said positioning plate and said positioning rod.

7. The labeling machine as claimed in claim 1, wherein said power drive is selected from the group of motors and servomotors.

8. The labeling machine as claimed in claim 1, wherein said first driving mechanism comprises an air cylinder coupled to and drivable by said second driving mechanism, said air cylinder comprising a piston rod, said piston rod having a free end thereof connected to said suction device, said piston rod being drivable by said second driving mechanism to move in and out of said air cylinder and to simultaneously move said suction device horizontally forwards or backwards.

9. The labeling machine as claimed in claim 8, wherein said second driving mechanism comprises a screw device and a motor, said motor of said second driving mechanism being coupled with said screw device and electrically coupled to said control unit and controllable by said control unit to rotate said screw device clockwise and counter-clockwise for causing said first driving mechanism to move upwards or downwards along said screw device; said air cylinder of said first driving mechanism is coupled to said screw device of said second driving mechanism; said first driving mechanism comprises a guide device connected to said air cylinder of said first driving mechanism.

10. The labeling machine as claimed in claim 1, further comprising a label blanking sensor facing toward said continuous label strip near said label strip let-off reel and remote from said label strip take-up reel, and adapted for detecting a no-individual label status.

11. The labeling machine as claimed in claim 1, further comprising a lift position sensor disposed near said screw device and adapted for detecting the position of said first driving mechanism during vertical displacement of said first driving mechanism.

12. The labeling machine as claimed in claim 1, wherein said suction device comprises a suction head rotational operating air cylinder for adjusting the angular position of said suction head.

13. The labeling machine as claimed in claim 1, which is joined with a film roll/bags-on-a-roll making machine, which comprises a feeding unit, a reel displacement unit, a cut-off mechanism, a material holding unit, a smoothening unit and a machine base, and disposed adjacent to a film-cutting position of said reel displacement unit between a film roll/bags-on-a-roll and said smoothening unit reel displacement unit.

14. The labeling machine as claimed in claim 13, wherein said film roll/bags-on-a-roll making machine further comprises a smoothening unit disposed near said film roll/bags-on-a-roll in said reel displacement unit, said smoothening unit comprises a smoothing unit pneumatic cylinder, a smoothing roller and a smoothening unit power drive, said smoothening unit power drive being coupled with said smoothing roller, said smoothing unit pneumatic cylinder being controllable to move said smoothing roller into contact with said film roll/bags-on-a-roll, said smoothening unit power drive being controllable to rotate said smoothing roller for smoothening said film roll/bags-on-a-roll and the adhered said individual label.

15. The labeling machine as claimed in claim 2, further comprising a guide wheel disposed between said third roller and said label strip take-up reel and adapted to guide said continuous label strip away from said label strip let-off reel for enabling said continuous label strip to be smoothly tack up by said label strip take-up reel.
